(19) United States
(12) Patent Application Publication
(10) Pub. No.: US 2007/0087101 A1
(43) Pub. Date: Apr. 19, 2007

(54) Soy-fortified corn dough and tortillas

(76) Inventors: Todd W. Gusek, Crystal, MN (US); Michael A. Porter, Maple Grove, MN (US); Ian C. Purtle, Plymouth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/251,096

(22) Filed: Oct. 14, 2005

(51) Int. Cl. A21D 10/00

(52) U.S. Cl. 426/549

(57) ABSTRACT

A method for producing a soy and corn dough mass is disclosed, the soy and corn dough mass comprising hydrated cracked corn and soy. The soy component of the soy and corn dough mass can be hydrated soy or non-hydrated soy. In one embodiment, both non-hydrated and hydrated soy can be part of the soy and corn dough mass. Tortillas and other traditional corn products can be made from the soy and corn dough mass.

### FIELD OF THE INVENTION

The invention relates to the formation of a processed corn-soy dough and to tortillas and dried corn-soy flours formed from the fresh corn-soy dough.

### BACKGROUND OF THE INVENTION

The history of the corn tortilla has Indian roots and goes back to the origin of the Mexican town. In the traditional processing approaches, the basic stages for tortilla preparation have remained unaltered from those times. The corn tortilla is the most important food of Mexico and for some countries of Central America. Corn tortillas are considered the main protein source and calorie source for social groups of low economic levels. Corn tortilla consumption is presently on the increase in the United States. Also, the corn tortilla is a basic ingredient in the production of a variety of traditional foods such as snack foods, tacos, tostadas, enchiladas, burritos and nachos. In Mexico, under diverse forms of consumption, the tortilla is part of the diet at all social levels with an annual consumption of up to 120 kg per capita. In rural areas, corn tortillas make up approximately 70% of the total ingested calories, constituting the main source of food.

The tortilla making process involves the formation of corn dough called masa. The traditional nixtamalization process consists of an alkaline processing of the corn grain in boiling water for 30-40 minutes at a water-to-corn ratio of about 3 parts water to 1 part corn. Before cooking, 1-2 weight percent lime as a fraction of the corn weight is added. After this cooking step, the cooked corn is left in the water for a period of 12 to 18 hours. The resulting hydrated corn separated from the excess water is called nixtamal, and the liquid rich in cooked solids is called najayote, which is wastewater that must be disposed such as by draining to a sewer. The nixtamal is washed to remove solubilized pericarp and excess lime. The washing consumes 1 to 2 parts of additional water per part of dry corn, and this water is additional wastewater that must be disposed. After washing, the nixtamal is milled, such as with a stone mill, with the addition of small volumes of water. After milling, the resulting dough (masa) can be molded to form tortillas and cooked. The traditional cooking of the tortilla generally involves the cooking of both sides of the tortilla at temperatures of 180-210° C. on a mud, metallic or ceramic surface for approximately 2 minutes.

At a commercial level, the corn may be cooked using different processes such as processes that involve cooking in containers with injected steam or continuous processing of drums of corn for forming nixtamal. In some processes, pots containing corn, water and lime are injected with steam until they reach a temperature near boiling. Lower temperatures generally can be used for snack production rather than tortilla production. Then, the mixture is left to settle for the remaining hydration period. For the production of fresh dough, the nixtamal is washed and milled. The washing process, for example, can be performed in rotary horizontal barrels or drums where the water is added in the form of a spray. For the production of tortillas, the dough is formed in circular pieces, and the cooking can be performed on bands/conveyors in which the pieces are flash heated to temperatures between 300-320° C., for example, with LP gas. Alternatively, the fresh dough can be dried and ground to form a flour of cooked corn. Dried precooked or instant (dry masa) corn flour is gaining in popularity, especially in the urban population due to the reduction of intensive and tedious work of the traditional process.

As noted above, corn tortillas are considered the main protein source for social groups of low economic levels. Traditional sources of protein, such as meat and fish, may be too expensive and/or difficult to obtain for individuals of low income. Corn can contribute, among other nutrients, sulfur-containing amino acids. Soybeans contain protein and include eight “essential” amino acids that are required in a healthy human diet; isoleucine, leucine, lysine, methionine, phenylalanine, threonine, tryptophan, and valine.

### SUMMARY OF THE INVENTION

In a first aspect, the invention pertains to a process for producing a corn-soy dough, the process comprising milling a corn-soy composition, the corn-soy composition comprising hydrated cracked corn and soy. The process includes the nixtamalization of corn and soybeans. The nitamalization process comprises hydrating a corn and soy composition for a time of at least 5 minutes, and in some embodiments from 5 minutes to about 5 hours, and in other embodiments from 5 minutes to about 18 hours. The corn and soy composition comprises a blend of a cracked corn, soy, water and no more than about 0.55 weight percent lime relative to the cracked corn weight. The hydrated corn and soy are milled to form a corn-soy dough.

In a further aspect, the invention relates to an alternative process for making the corn-soy dough. The process comprises hydrating cracked corn for a time of at least 5 minutes, and in some embodiments from 5 minutes to about 5 hours, and in additional embodiments from 5 minutes to about 18 hours. The process further comprises milling the hydrated corn and the soy, to form a corn-soy dough.

In an additional aspect, the invention relates to another additional or alternative process for making a corn-soy dough. The process comprises hydrating cracked corn and soy for a time of at least 5 minutes, and in some embodiments, from 5 minutes to about 5 hours, and in yet other embodiments from 5 minutes to abut 18 hours. The process further comprises milling the hydrated corn and soy with additional soy, to form a corn-soy dough.

In another aspect, the invention relates to a corn-soy dough mass comprising a generally uniform hydrated cracked corn and soy composition.

### BRIEF DESCRIPTION OF THE DRAWINGS

FIG. 1 is a flow chart depicting an embodiment of a process for making corn-soy dough, wherein hydrated cracked whole corn kernels and soy are milled into corn-soy products such as tortillas or dried corn-soy flour.

FIG. 2 is a flow chart depicting an embodiment of a process for making corn-soy dough, wherein hydrated cracked whole corn kernels and soy are milled into corn-soy products such as tortillas or dried corn-soy flour.

FIG. 3 is a flow chart depicting an embodiment of a process for making corn-soy dough, wherein hydrated cracked whole corn kernels and soy are milled into corn-soy products such as tortillas or dried corn-soy flour.

FIG. 4 is a flow chart of an embodiment of a process for milling hydrated corn and soy in which the soy is added to the hydrated corn at milling.

FIG. 5 is a flow chart of an embodiment of a process for milling hydrated corn and soy in which the soy is added to the hydrated corn at milling.

FIG. 6 is a flow chart of an embodiment of a process for milling hydrated corn and soy in which the soy is added to the hydrated corn at milling.

FIG. 7 is a flow chart depicting an embodiment of a process for making corn-soy dough, wherein soy is milled with a hydrated corn and soy composition.

FIG. 8 is a flow chart depicting an embodiment of a process for making corn-soy dough, wherein soy is milled with a hydrated corn and soy composition.

FIG. 9 is a flow chart depicting an embodiment of a process for making corn-soy dough, wherein soy is milled with a hydrated corn and soy composition.

### DETAILED DESCRIPTION OF THE INVENTION

Processes have been discovered for the commercial production of a corn-soy dough, for use in making tortillas and other traditionally corn dough based products, that provides additional nutritional benefits over the traditional corn dough used for tortilla-making. The addition of soy to the process of making the traditional corn dough or masa, provides for a source of essential amino acids not found at desired levels in traditional corn dough used for tortilla-making. In particular, the addition of soy provides a desirable source for the eight “essential” amino acids required for a healthy human diet. Essential amino acids in soy include, for example, isoleucine, leucine, lysine, methionine, phenylalanine, threonine, tryptophan, and valine. The soy component of the corn-soy dough provides, among other benefits, carbohydrates, fats, calcium, phosphorus, iron, fiber, and folic acid.

In processes described herein, soy compositions are incorporated into the process to form a corn-soy masa blend, which can then be used to make a range of corn food products. The soy generally can be supplied as a dried soy product that may have been suitably prepared and stored prior to incorporation into the nixtamalization process. Through the incorporation of the soy into the nixtamalization process a masa can be produced that has desirable properties, such as a more uniform consistency, and the process can be simplified since the soy composition is directly blended and hydrated during formation of the hydrated corn-soy blend, which is the equivalent of a corn masa except for the addition of the soy composition.

The processes described herein provide for the addition of soy to the traditional or non-traditional process for making corn dough/masa such that a uniform dough comprised of corn and soy is formed. The traditional process for making corn dough/masa involves steeping unfragmented corn kernels for hours or overnight in water, rinsing and then stone milling the hydrated corn. In some embodiments, non-traditional processes comprise hydrating cracked corn in less water and for less time than the traditional process, and stone milling the hydrated corn. Suitable forms of soy are available, including, for example, soy grits, whole soy meal, defatted soy flakes and soy flour. In one embodiment, the soy is added to the cracked corn at the start of the hydration or nixtamalization process, such that the soy also undergoes hydration concurrently with the corn. The conditions of hydration provide an opportunity for the soy to introduce desirable physico-chemical changes to the hydrated and corn-soy composition and ultimately to the tortilla.

Alternatively, soy may be added to the nixtamalized corn at the milling step. Generally, at the end of the nixtamalization process, the corn generally is milled, such as stone milled, into a consistency of a corn masa. Soy can be added to the hydrated corn at the milling step, such that the soy and corn are ground and blended together. Additional water can be added at this stage, for example, the supply water to hydrate the soy composition. A corn-soy dough with the consistency similar to a corn masa is formed during this milling process. The corn-soy dough has desirable characteristics for forming food products, and incorporating soy during the formation of the dough provides an opportunity to better disperse and blend the soy than post-addition of soy to prepared dough or flour.

Further, in another embodiment, soy can be added to the corn at the start of the hydration process as well as at the milling step. Additionally or alternatively, a soy composition can be blended with the hydrated corn mixture at an intermediate stage of the corn hydration process. Additional heat and/or water may or may not be added to compensate for the addition of the soy.

The processes described herein provide for making a corn-soy dough, which can be used to make tortillas and other corn-based products. In addition, the corn-soy dough can be dried to form instant flour that can be used later to form rehydrated dough. The products made from the corn-soy dough or flour provide additional nutrients, such as protein, that may be in short-supply in a largely corn-based diet.

The processes described herein are generally based on the use of cracked corn that is hydrated. Any variety/genotype of corn can be used in the nixtamalization process, although certain corn varieties may be desirable due to taste, texture and other properties. For example, in Mexico, white corn varieties are traditionally used to form masa. Corn is removed from the cob as kernels. The whole kernel can be used in the nixtamalization processes described herein. Alternatively, portions of the pericarp and/or germ can be removed to form decorticated corn for further processing, as described further below. In some embodiments, for performing the hydration process, the kernel can be cracked in a mill or the like. Generally, the corn initially has roughly 10 to 15 weight percent water as received from growers, although this water amount can vary due to a variety of factors. The amount of water added in the hydration process can be adjusted to obtain a desired hydration level for the resulting dough. In general, the relevant parameters for the commercial processing to form nixtamal (hydrated washed corn) include, for example, the type of corn, time and temperature of heating, alkaline/lime concentrations, frequency of stirring to maintain the lime in suspension and the process of washing the nixtamal.

Generally, any variety or genotype of soybean can be added to the nixtamalization process, although certain varieties of soybeans may be more desirable due to taste, texture, and processability. Soy, i.e., soybeans or a portion thereof, can be added to the nixtamalization process in a variety of forms including, for example, cracked whole soybeans, preground whole soybean meal, full-fat soybean flakes, defatted soy flakes, full-fat or defatted soy flour, soy grits, isolated soy protein (i.e. concentrate, isolate, textured) or combinations thereof. The corn and soy are hydrated as described below, although more water may be desirable to hydrate the corn-soy mix than is generally used to hydrate just the corn to form a masa. The selected amount of added water may be in reasonably equivalent proportions based on the added weight of soy, with hydration as the primary goal.

The nixtamalization process involves hydration and milling to form fresh dough. The hydration of the corn and soy, if added at this stage, generally involves the addition of desired amounts of water and lime to form a hydration mixture. The hydration mixture can be heated to facilitate the hydration process. During the hydration process, the starch of the corn kernel generally becomes hydrated. The time of the hydration process can be selected to yield appropriately hydrated corn and soy product. It is desirable that to at least some degree the starch is gelatinized. In some embodiments, relatively high temperatures are used for the water prior to addition to the corn and soy, and additional heat may or may not be added during the time of hydration. In some embodiments, with the balance of processing features described herein, reduced amounts of lime can be used relative to traditional nixtamalization processes. Processing features are described further below.

At the end of the selected period of time, the hydrated corn-soy blend generally can be ready for further processing into dough without washing or removal of excess water. However, dependent upon the nixtamalization process, washing and removal of excess water can be performed. The milling of the hydrated corn-soy blend is performed to produce smooth, fresh corn-soy dough. Milling can be performed in a stone mill or other mill such as mills that provide for the application of shear force without excessive mechanical damage to the starch or other chemicals in the grain or soy. In the milling process, the corn particles (nixtamal) are crushed into small particles that form the cohesive structure of the dough. If the soy is present as larger particles, the soy is also crushed with the hydrated corn and further blended so that the resulting dough contains an even distribution of soy throughout the matrix of the dough.

After milling, the fresh corn-soy dough is ready for further processing. Specifically, the milled product can be a partially gelatinized material that can be utilized, for example, in the formation of traditionally corn products. While nixtamalized corn is generally considered cooked, the distinguishing characteristic of nixtamalized corn is the dispersion and hydration of starch concentrations in the corn kernel such that fine dough is formed that is cohesive and machinable but not significantly sticky. The addition of hydrated soy may increase the stickiness of the dough and end-products. Hydrated soy may also provide end-products with improved taste and shelf-life. The hydration of the corn kernel and soy can be effected by a combination of effects generally, with a contribution from heating.

Alternative to the process described above, corn, without the addition of soy, can be hydrated utilizing a variety of different processes, as described below. The nixtamalized corn is prepared for milling, and soy is added to the hydrated corn prior to milling. The soy that is added to the hydrated corn can be in the form of, for example, preground whole soybean meal, defatted soy flakes, soy grits, full-fat or defatted soy flour, isolated soy protein (i.e. concentrate, isolate, textured) or combinations thereof. Depending upon the desired flavor, nutrition and protein functionality, the meal flakes and/or flour can be selected with the appropriate protein dispersibility index (PDI). PDI values typically span 20%-90%. PDI is a measure of the percent of total protein that disperses in water under standard conditions (water dispersible protein expressed as a percent). PDI is used as a measure of the degree of processing of soybean meal and is correlated with the amount of heat to which soy flour is exposed during production. Generally, PDI values between 10% and 30% reflect adequate heat treatment for good protein nutritional value, where a higher percent figure indicates under heating the soy and lower percent values indicate overheating the soy. Yet another alternative to the above processes is to take the hydrated corn and soy composition described above and to add additional soy to the corn-soy composition prior to milling. Process parameters can be altered to accommodate the total amount of soy.

Following hydration and milling of the corn and soy, the fresh dough can be processed into tortillas or other products, stored for later use and/or dried. The tortillas can be immediately consumed, stored for later consumption or fried into tacos, chips or the like. The formation of tortillas and other products is described further below. Alternatively or additionally, the fresh corn-soy dough can be stored for distribution to tortilla manufacturing operations, individuals and the like for the formation of tortillas and other products from the fresh dough. In some embodiments, some or all of the corn-soy dough can be dried to form a dried corn-soy product. Formation of dried flour can involve dehydration, milling and, optionally, sieving. Specifically, the dried dough can then be milled into flour with a desired consistency. Thus, the processes herein can be used in the preparation of fresh corn-soy dough and/or dry instant corn-soy flour with improved nutritional properties compared with traditional corn masa.

The resulting flour can be instant corn-soy flour since the starch in the product is effectively hydrated or gelatinized by the nixtamalization process. Thus, the corn-soy flour can be rehydrated in a relatively short period of time to form re-hydrated dough that can be formed into tortillas or other traditionally corn products. Also, reduced hydration can be used in re-forming the nixtamalized corn-soy dough since the dehydration process causes additional gelatinization. Processing parameters can significantly affect the properties of the resulting flours. General processes for the formation of instant corn flours are described, for example, in U.S. Pat. No. 2,584,893 to Loyds et al., entitled “Method Of Making a Tortilla Flour,” U.S. Pat. No. 3,194,664 to Eytinge, entitled “Method For Continuously Producing Nixtamal,” and U.S. Pat. No. 4,513,018 to Rubio, entitled “Continuous Production Of Corn Products,” all of which are incorporated herein by reference.

In contrast with the approaches described herein to produce a nixtamalized corn-soy composition and dried corn-soy flour, other methods of nixtamalization of corn can be adapted to produce hydrated corn-soy dough and dried masa flour. Montemayor and Rubio describe a continuous process and batch process for the production of cooked corn in the formation of instant corn flour. (“Alkaline cooked corn flour: technology and uses in tortilla and snack products,” abstract Cereal Food World, 28-577 (1983), incorporated herein by reference.) In these processes, lime is mixed with corn and water in a spiral transporter connected with a steam injector. The corn is cooked as it is transported. After cooking, the product is washed to remove part of the pericarp and excess lime. After washing, the corn is dehydrated and milled to obtain flours.

Molina et al. describe the production of instant flours using drum dryers operating under pressure. (Molina et al., “Drum drying technology for the improved production of instant tortilla flour,” J. Food Science, 42: 1432-1434 (1977), incorporated herein by reference.) Mendoza describes a process using steam cooking after the addition of lime. (U.S. Pat. No. 3,859,452 to Mendoza, entitled “Method For Obtaining Nixtamalized Flours,” incorporated herein by reference). Flour production has been described based on infrared radiation. See, for example, U.S. Pat. No. 4,555,409 to Hart, entitled “Cereal Processing,” and Johnson et al., “Tortilla-making characteristic of micronized sorghum and corn flours,” J. Food Science 45:671 (1980), both of which are incorporated herein by reference.

The benefits of forming nixtamalized corn-soy dough described herein can be carried over to the formation of dried corn-soy flour in addition to the formation of products from fresh corn-soy dough. The benefits provided by the soy component may vary, however, in any case, the soy component provides for a generally more nutritious end-product than an end-product consisting of just corn.

Composition Of Corn-Soy Dough

The processing of corn kernels and soy to form a hydrated corn-soy composition as described herein generally comprises the formation of crushed corn kernels and soy that are combined with water and an alkaline composition/lime to form a hydration mixture. The hydration mixture can then be stored for the hydration period with optional mixing and generally heated during at least a portion of the hydration period to obtain desired levels of hydration/gelatinization of the corn and soy material. While embodiments can include lime in various concentrations, in some embodiments the amount of lime is significantly less than in the traditional tortilla production process. Following hydration of the corn and soy, the corn-soy blend can be further processed into desired products.

The corn can be obtained generally from corn plants of any variety of corn (Zea Mays). Certain corn plants may be desirable for the particular taste of the corn kernel, and this taste can vary from one population to another. Corn used in the traditional nixtamalization process is appropriate for the processes described herein. In Mexico, white corn is traditionally used for the formation of masa. In addition, generally any variety of soybean (Glycine-max (L) Merrill) can be used along with the corn in the hydration process. The form of the soy used may be dependent upon what is available locally as well as on processing parameters and the desired taste and consistency of the processed product. Soy in the form of preground whole soybean meal, defatted soy flakes, full-fat or defatted soy flour, isolated soy protein (i.e. concentrate, isolate, textured) or combinations thereof, among other forms, may be used in conjunction with corn in the hydration process.

The hydration process can incorporate whole corn kernels or portions thereof. The whole corn kernels are removed from the cob, and generally the kernels are cleaned to remove cob fragments and other contaminants. Methods of cleaning the kernels can be wet or dry and can include sieving, screening and washing. The major portions of a corn kernel are the pericarp, the endosperm and the embryo or germ. The outer portion of the corn kernel is called the pericarp and is fibrous consisting mainly of cellulose. The fibrous nature of the pericarp can make it difficult to process into nixtamalized corn dough. However, whole corn kernels with the entire pericarp can be kept in the processes described herein to form high quality corn dough (masa) and resulting tortilla products with desirable texture and taste. Nevertheless, portions or all of the pericarp and/or germ can be removed prior to processing into nixtamalized corn. The corn following removal of portions of the grain can be referred to as decorticated corn. Removal of parts of the kernel can result in the loss of significant nutrients, such as fat, fiber, protein and vitamins, as well as in a lower yield of nixtamalized corn dough. Similarly, different portions of the corn kernel can be processed differently for the formation of nixtamalized corn.

In some embodiments, the corn kernels are crushed prior to the hydration step. If desired, fine particles of corn can be separated, for example for separate processing. Similarly, the pericarp can be separately processed and recombined into a final product. The crushing process and the processing of the corn prior to hydration is described further below. However, a particular amount of corn is incorporated into the hydration process, and this amount of corn is generally the standard by which other quantities are evaluated with respect to amounts. Thus, the quantity of corn used for hydration can comprise, for example, crushed corn kernels, unfragmented kernels, portions thereof or combination thereof.

The soy that is used in the hydration process can incorporate whole soybeans or parts thereof. Soybeans are cleaned and dried prior to processing. During the drying process the hull of the soybean may be removed. The hull may be ground and used for other purposes such as providing fiber to breads, cereals and snacks. Alternatively, the hull can be added to the hydration solution along with the corn to be hydrated. The hull is high in fiber and therefore may be difficult to process into nixtamalized corn-soy dough. After dehulling, the soybeans can be rolled into flakes and the oil can be removed, thus forming defatted soy flakes. Alternative to adding ground soybean meal, soybean flakes can be added to the hydration mix and can be hydrated along with the corn. Soy flour is produced by grinding and screening the defatted soy flakes. Instead of removing the hull, the hull can remain on the soybean and the whole soybean can be ground, thus forming whole soybean meal. This soybean meal can be hydrated along with the corn to form the corn-soy dough. Yet another alternative form of adding soy to the hydration process is to add soy in the form of soy flour, and the soy flour and the corn can be hydrated together. A particular amount of soy is incorporated with the corn in the hydration process, and the soy can comprise ground whole soybean meal, defatted soy flakes, soy flour, or other forms of soy. In one embodiment, the amount of soy is at least 0.1 weight percent of corn, in another embodiment the amount of soy is from 0.5 weight percent to about 8 weight percent of corn, in yet another embodiment the amount of soy is from 1.0 weight percent to about 10.0 weight percent of corn, and in yet another embodiment the amount of soy is from about 1.5 weight percent to about 8 weight percent of corn. A person of ordinary skill in the art will recognize that additional ranges of soy amounts within the explicit ranges are contemplated and are within the present disclosure.

The selected soy and corn, with any preliminary processing, are hydrated. Alternatively, just the corn may be hydrated and non-hydrated soy can be added to the hydrated corn prior to milling. Another option in forming the corn-soy dough is to add non-hydrated soy prior to the milling step, to hydrated corn and hydrated soy. To perform the hydration, selected amounts of water, lime and any additional additives are combined with the soy and corn, or alternatively, with the corn alone. The addition of a desired amount of water for hydration, with all of the water being incorporated into the hydrated corn-soy materials, eliminates the removal and disposal of any excess water. In forming fresh dough, water is incorporated into the corn-soy mass such that dough with appropriate consistency is formed

In general, the amount of water is selected to yield a selected total amount of water. Thus, if the initial amount of water in the corn and soy is estimated, the amount of added water can be adjusted to yield the desired hydration level for the resulting nixtamalized corn-soy and corresponding fresh dough. Generally, the corn obtained from farmers for the formation of nixtamalized corn has a humidity level in the range from about 10 weight percent to about 15 weight percent, although total water levels can be adjusted for other values of initial water content. Generally, the dried soybeans have a humidity level in the range of about 10 weight percent to about 13 weight percent. The total water content of the nixtamalized corn-soy can be adjusted to desirable values although for a reasonable period of hydration time there may be a limit on the amount of water that can be approximately homogenously incorporated into the corn and soy. Generally, the water is added during the hydration period although additional water can be added at the milling stage at which the hydrated corn and soy is milled to form fresh dough.

For the production and sale of hydrated, fresh dough, it is generally desirable to incorporate a larger amount of water into the dough. Higher amounts of water result in increased yields as determined by the weight of the dough. However, for the production of dry, cooked corn-soy flour (e.g., instant dry masa flour), without intending to be limited by theory, additional gelatinization of the corn starch may take place during the drying process such that less water can be used to produce the corresponding fresh dough while subsequently forming a corn-soy flour that yields traditionally all-corn products with the desired consistency and taste. Since energy is required to remove the water to form a dry flour, the use of less water also results in an energy savings. The nixtamalized corn-soy as a fresh dough generally has a total humidity content from about 40 weight percent to about 60 weight percent and in other embodiments from about 45 weight percent to about 55 weight percent and in further embodiments from about 50 weight percent to about 52 weight percent. Total humidity levels of about 50 weight percent result in excellent properties for the fresh dough, especially cohesion, and especially for the resulting tortillas, highly reproducible product properties. A person of ordinary skill in the art will recognize that additional ranges of humidity levels within these explicit ranges are contemplated and are within the present disclosure.

An alkaline composition, generally lime, can be added to the hydration mixture to facilitate the hydration process. Suitable alkaline agents include, for example, calcium oxide, calcium hydroxide and mixtures thereof. Lime is a common name for calcium oxide, CaO, and calcium hydroxide, (Ca(OH)₂), also know as slaked lime. Lime dissolves in water to form calcium hydroxide. In some embodiments, lime is added to result in a pH of about 6 to about 9.0 and in other embodiments from about 6 to about 7.5 pH units. A person of ordinary skill in the art will recognize that additional ranges within these explicit ranges of pH are contemplated and are within the present disclosure.

In general, the amount of lime may be no more than about 2.5 weight percent, in other embodiments, no more than about 0.55 weight percent and in further embodiments from about 0.1 weight percent to about 0.3 weight percent and in additional embodiments from about 0.1 weight percent to about 0.25 weight percent. A person of ordinary skill in the art will recognize that additional ranges of lime concentration within these explicit ranges are contemplated and are within the present disclosure. These weights are based on Ca(OH)₂, which is the form of food grade lime. To the extent that calcium oxide is used rather than calcium hydroxide, the weight of calcium oxide can be correspondingly evaluated by considering the desired amount of calcium hydroxide as a combination of CaO and H₂O such that the weight can be distributed accordingly as calcium oxide and water. Then, the lower weight of calcium oxide can be added and a correspondingly larger amount of water can be added.

Processing To Form Corn-Soy Dough

In some embodiments, the formation of nixtamalized corn-soy blend can comprise, for example, cracking the corn, processing the soy, combining the corn and soy with, at least, water and lime, hydrating the corn-soy mixture and milling the hydrated corn-soy composition. The preparation of the cracked corn can involve separation of corn components either for separate processing or inclusion of only a portion of the corn kernel in the nixtamalization process. The processing of the soy can involve drying and separation of the soy component with separate processing or inclusion of only a portion of the whole soybean in the hydration process. The hydration process generally involves the addition of heat to achieve the hydration mixture at or near a selected temperature for at least one period of time during the hydration period. The milling of the hydrated corn-soy mixture forms fresh dough (masa). The fresh dough can then be processed into such products as fresh tortillas or dried into flour, as described further in the following section. Generally, in some embodiments of particular interest, the process does not produce wastewater from the hydration process. However, if the certain corn hydration (nixtamalization) processes are used, then, generally, wastewater may be generated.

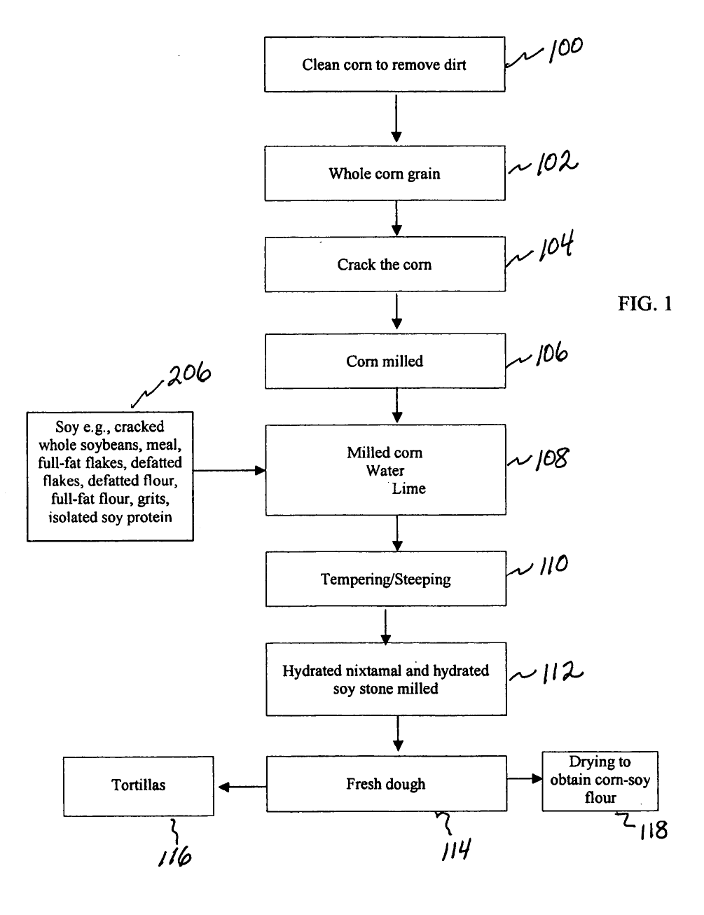

One embodiment for the formation of nixtamalized corn-soy is outlined in FIG. 1. The corn removed from the cob optionally can be cleaned 100, for example, by sieving or screening in a dry process, or washing in a wet process, to remove impurities and to form the whole grain corn 102 for further processing. In some embodiments, the corn kernels are cracked prior to the hydration step. Specifically, the whole grain corn can be strained from the cleaning water and milled or cracked 104 to form milled corn 106.

Soy 206 and milled corn can be combined 108 with water, lime and any additional additives to form a hydration mixture. The hydration mixture can be settled 110 in an appropriate container for the completion of the hydration process. Occasional mixing may be performed to maintain homogeneity and uniform consistency of the hydration mixture. Following hydration, the hydrated corn-soy mixture can be milled 112 to form fresh dough 114. The fresh dough can be processed into products 116 or dried 118 to obtain corn-soy flour.

In some embodiments, a portion of the whole corn kernel is used in the formation of the nixtamalized corn-soy. For example, the corn can be processed to separate a portion of the corn kernels prior to continuing the processing. The removal of the outer portions of the kernel can be accomplished, for example, with mechanical abrasion or polishing. Specifically, the corn can be passed through a degerminating mill to remove the hull/pericarp from the remainder of the kernel, as described further in U.S. Pat. No. 4,738,772 to Giesfeldt, entitled “Process For Separating Fiber From Dry-Milled Corn,” incorporated herein by reference. Alternatively, the kernels can be passed through a polishing chamber with the amount of pericarp removed being related to the time spent in the polishing chamber. In one embodiment to perform the polishing, corn is introduced into a generally cylindrical chamber with perforations or slits along the longitudinal sides of the chamber. A rotating cylinder with protruding conveying flights moves the corn down the chamber while abrading corn against the perforations or slits removing the bran (i.e., pericarp). More or less polishing is accomplished by restricting the outlet of the chamber; more restriction results in higher level of polishing. The separated pericarp and/or other portions of the kernel can be discarded or separately processed for reincorporation into the nixtamalization process.

In general, the crushing or milling 104 of the corn kernels can be performed in a mill with hammers or blades that break up the kernels. In some embodiments, corn is introduced into a chamber where hammers or blades are rotating around a central axis. The hammers or blades impact the corn causing breakage such that the particles pass through a surrounding screen that is perforated with holes, the particle size being determined by the size of the holes in the screen. In some cases a screen is not used because the impact of the hammers or blades is sufficient to produce particle sizes desired. Suitable hammer mills are Jacobson, Buhler Inc. (Minneapolis, Minn.), and Bliss Industries (Ponca City, Okla.). This can be performed with whole corn kernels or kernels with the pericarp partially or totally removed. The breaking of the kernels facilitates the hydration process, although whole kernels can be used in the hydration process. While any breaking of the whole kernels can be advantageous, the kernels can be milled to a weight average particle size of no more than about 5 mm. In other embodiments the weight average particle size may be no more than about 4.5 mm. The particle size of milled kernels can vary from about 8.0 mm to 0.1 mm and in further embodiments from about 6.0 mm to about 0.1 mm. Particle size can be evaluated by the ability to pass through sieves with standard sized openings.

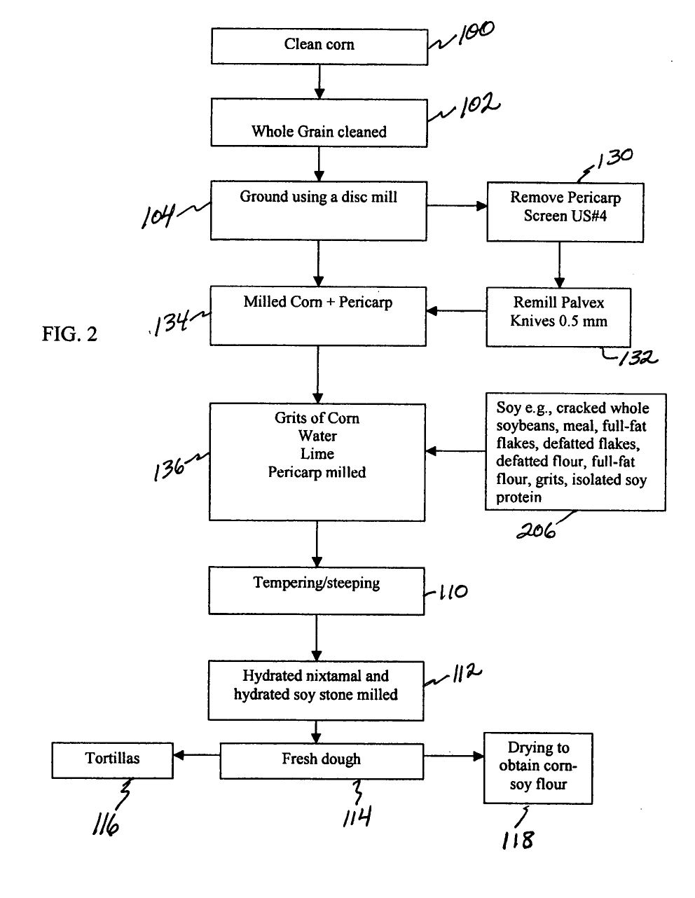

In some embodiments, the milling 104 of the corn kernels can be used to facilitate separate processing of different portions of the corn kernels. Referring to FIG. 2, whole corn is ground 104, and the milled corn can be passed 130 over a screen, such as a U.S. number 4 screen, to separate a portion that includes an enhanced fraction of the pericarp, which remains on the screen as the remaining portions pass through the screen. The pericarp is fibrous such that it remains in larger sections in the crushing process.

It may be desirable to reintroduce the pericarp into the nixtamalization process such that the yield is not reduced. Also, the hydration of the pericarp can be facilitated by further milling of the pericarp into smaller fragments. Referring to FIG. 2, the pericarp can be remilled 132, for example, with a mill having blades, to produce pericarp fragments, such as fragments with an average particle size of about 0.5 mm or less. The remilled pericarp can be recombined 134 with the remaining portions of the cracked corn kernel to form a crushed corn blend. Then, the crushed corn blend can be combined 136 with soy 206, water and lime to form a hydration mixture including the initially crushed corn that passed through the sieve and the remilled pericarp. Alternatively or additionally, the components or portions thereof of the hydration mixture can be combined in a different order to form an equivalent hydration mixture. This hydration mixture can be hydrated and further processed to form the desired products.

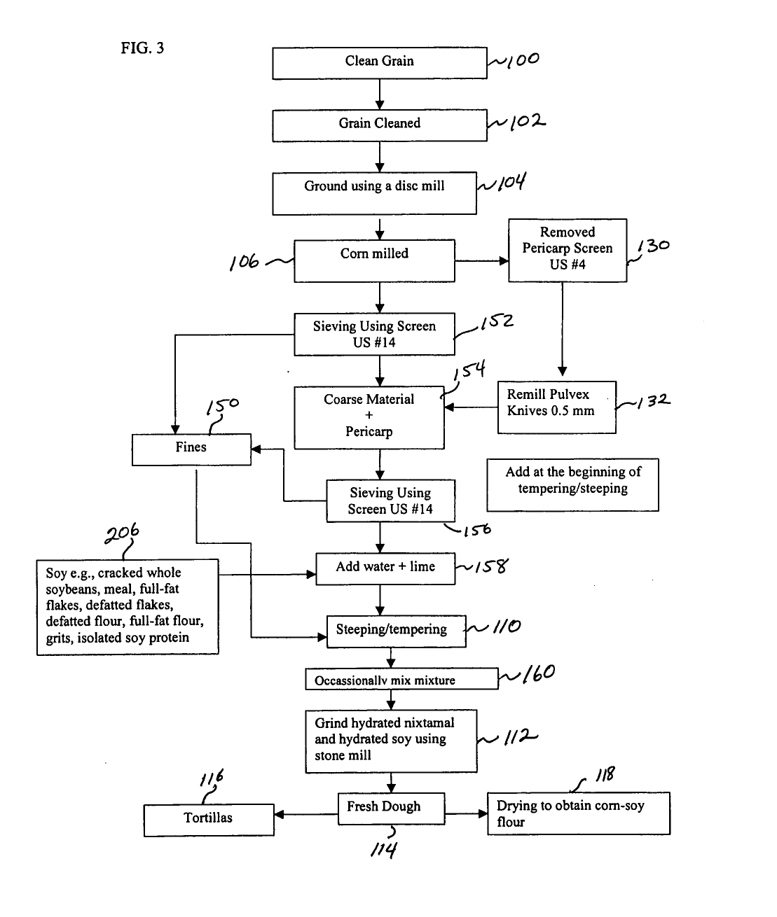

In additional embodiments, the crushed corn kernels are sieved to separate fines that are introduced into the hydration process at a later stage such that the fines are not processed for hydration as long as the other portions of the corn. Since the fines do not need to be hydrated as long, the introduction of the fines at a later stage reduces the energy needed to heat the hydration mixture for embodiments in which the hydration mixture is heated during the hydration process and may reduce the processing time. Furthermore, by reducing the competition for water between the fines and the remaining portions of the cracked corn and soy, more uniform hydration can be achieved such that a more uniform dough/masa is obtained. Referring to a specific embodiment in FIG. 3, after the corn is milled 106, the fines 150 can be removed by sieving using a U.S. Number 14 screen 152. Alternatively, after removal of some or all of the pericarp 130, the fines 150 are separated 156 from the remaining portions of the kernel by passing the fines through a U.S. Number 14 screen 156 while the coarser portions remain on the screen. The pericarp can be remilled 132 and recombined with the milled corn with the fines removed 154.

If the pericarp is separately remilled, the remilled pericarp and/or the recombined milled kernels and remilled pericarp can be passed 156 over a Number 14 screen to separate additional fines, which pass through the screen while coarser portions remain on the screen. The total amount of fines collected can be introduced into the hydration mixture at a later stage of the hydration process, such as twenty minutes prior to the completion of the hydration process. The desired time for adding the fines can be determined empirically to obtain desired consistency of the dough. In some embodiments, the separating 156 of the fines after remilling of the pericarp can be performed without separating 152 of the fines at an earlier stage of the process. The crushed corn with the fines removed can be combined 158 with soy 206, water and lime to form a hydration mixture.

The soy 206 part of the hydration mixture can be comprised of a variety of different forms of soy. As noted above, the whole soybean can be used in the formation of the hydration mixture, as can other forms of soy, for example, soy flakes, soy grits, soy flour, soy meal and soy protein. The processing of soybeans generally involves some type of heat treatment of the soybeans. The heat applied to the soybeans, among other benefits, reduces or removes some of the anti-nutritional aspects of the soybean. For example, exposure of the soybeans to heat is important in inactivating trypsin and chymotrypsin proteases, as well as soybean trypsin inhibiter. In addition, the exposure to heat releases additional flavors and aromas from the soybeans. The soybeans may be ground in a mill prior to or after drying. The soybeans are dried to about 9%-11% humidity or moisture content. Processed soybeans, in various forms are available commercially from suppliers such as Cargill, Inc. of Minneapolis, Minn. The hydrating 110 of the crushed corn and soy 206 can be performed in any suitable container. In general, the hydration mixture can be mixed to combine the ingredients. The order of combining the ingredients may not matter. Furthermore, the hydration mixture can be mixed intermittently, periodically or continuously during the hydration process, although no mixing needs to be performed once the initial mixture is formed. For example, referring to FIG. 3, the hydration mixture can be mixed 160 every 2.5 minutes to obtain a more uniform composition and temperature through the mixture. The hydration process can be performed within a commercial mixer, blender or hopper of an appropriate size, which are readily available. The desired time for the hydration may vary somewhat depending on the particle sizes, temperature of hydration, the amount of mixing and the particular apparatus used to perform the hydration.

In general, the water may or may not be heated prior to combining with the corn, soy and/or other ingredients. In some embodiments of particular interest, the water is heated prior to addition to the corn and soy, although the corn and soy may cool the water below its initial temperature until additional heat can be added. In some embodiments, the hydration mixture is not heated further during the hydration process. For these embodiments, the hydration mixture generally is not mixed after an initial mixing so that the mixture does not cool excessively during the hydration process. Also, the mixture may be covered. In particular, the water, optionally with lime, can be heated at a temperature greater than room temperature, in some embodiments at least about 80° C., and in further embodiments from about 85° C. to about 95° C.

In other embodiments, the mixture is heated through the hydration period, although the temperature can vary during the hydration period. If heat is added during the hydration process, it may be desirable to mix the mixture occasionally or continuously to avoid any portion of the mixture from overcooking or drying. Furthermore, the temperature during the hydration process can fluctuate over a range and/or can be changed during different portions of the hydration process. The amount of heating can be selected to complete the hydration in a desired amount of time and to produce dough with desired texture. In particular, the hydration mixture can be heated at an average temperature greater than room temperature, in some embodiments at least about 80° C., and in further embodiments from about 85° C. to about 95° C. If heat is added after combining the water, the crushed corn and the soy, the hydration mixture can be mixed to prevent excess heating or drying of a portion of the mixture.

Whether or not the hydration mixture is heated after combining the water, the crushed corn and the soy, the process of hydrating the mixture generally can be performed for at least about 5 minutes, in some embodiments for about 5 minutes to about 5 hours, in further embodiments from about 30 minutes to about 4 hours and in additional embodiments from about 45 minutes to about 2 hours. A person of ordinary skill in the art will recognize that additional ranges within the explicit ranges of hydration temperatures and time are contemplated and are within the present disclosure.

In some embodiments of particular interest, the water is incorporated into the resulting hydrated corn-soy composition. In particular, the starch of the corn is hydrated/gelatinized such that the hydrated corn essentially retains the water within the mass. Generally, no excess water needs to be removed as wastewater. The hydrated nixtamalized corn-soy is moist with crumbly discrete corn particles. The hydrated corn-soy blend can then be milled into dough.

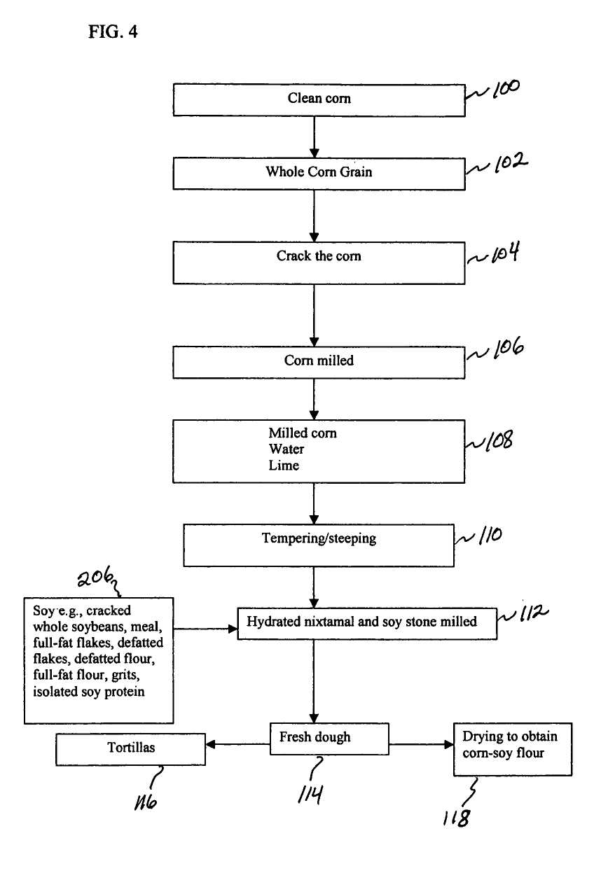

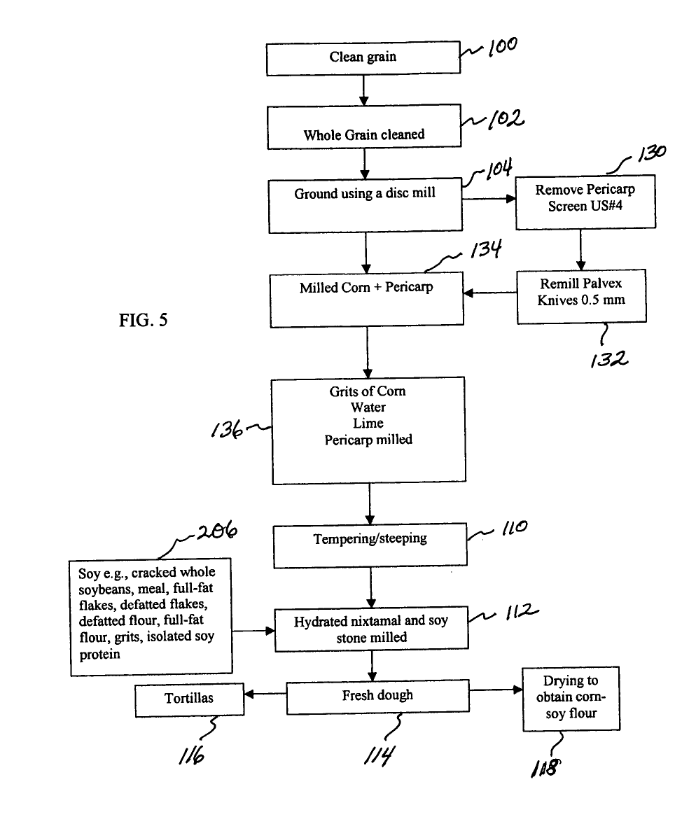

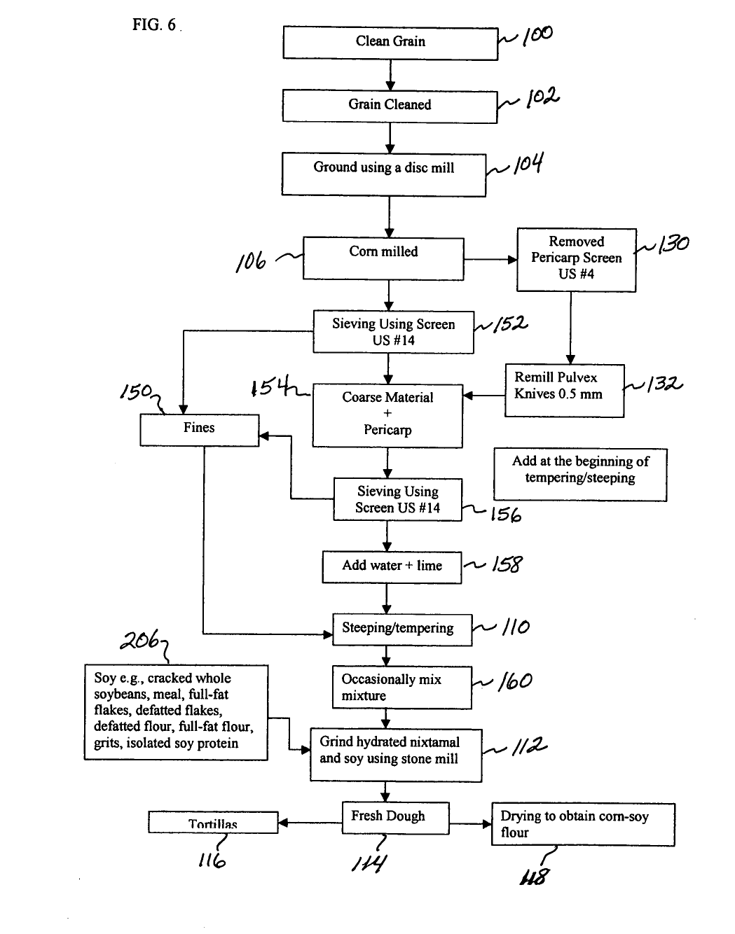

Alternatively, the hydration process described above can be used to hydrate just the corn. Referring to FIGS. 4-6, the corn is hydrated with an adjustment in additives, for example, water, to compensate for the removal of soy at this point of the process. However, the hydration process remains essentially similar. Once the corn is hydrated, the soy 206 is added to the corn prior to the milling process 112, but after the hydration and tempering processes. The added soy can be in the form, for example, of preground whole soybean meal, full-fat soybean flakes, defatted soy flakes, defatted or full-fat soy flour, soy grits or combinations thereof.

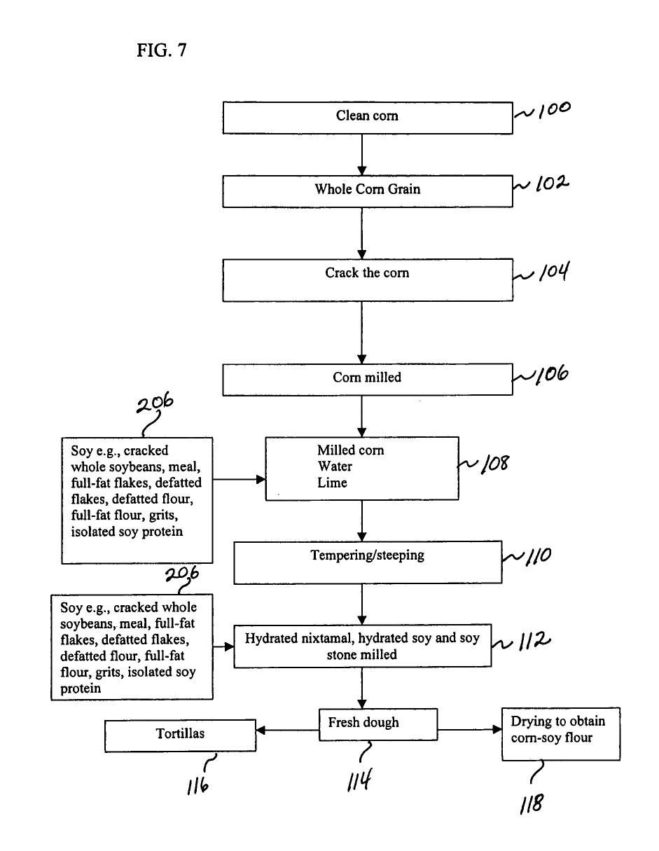

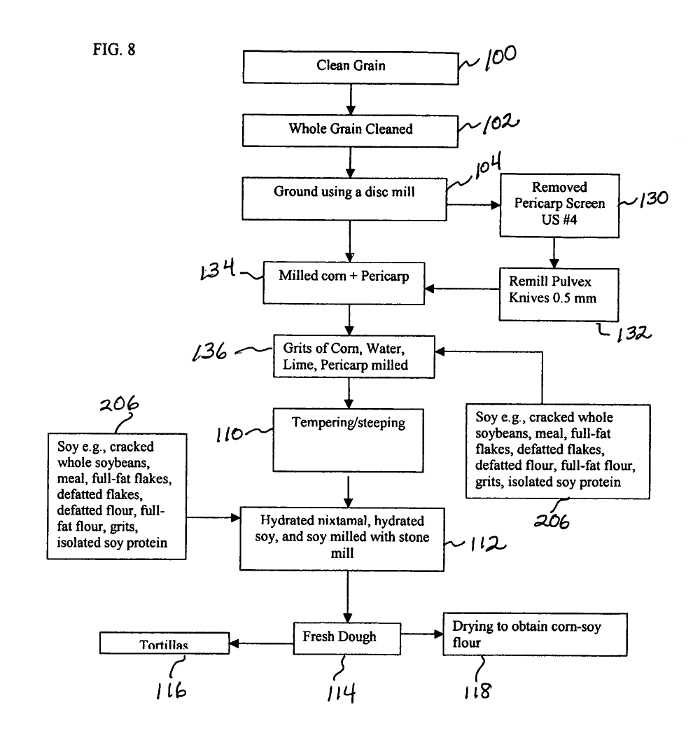

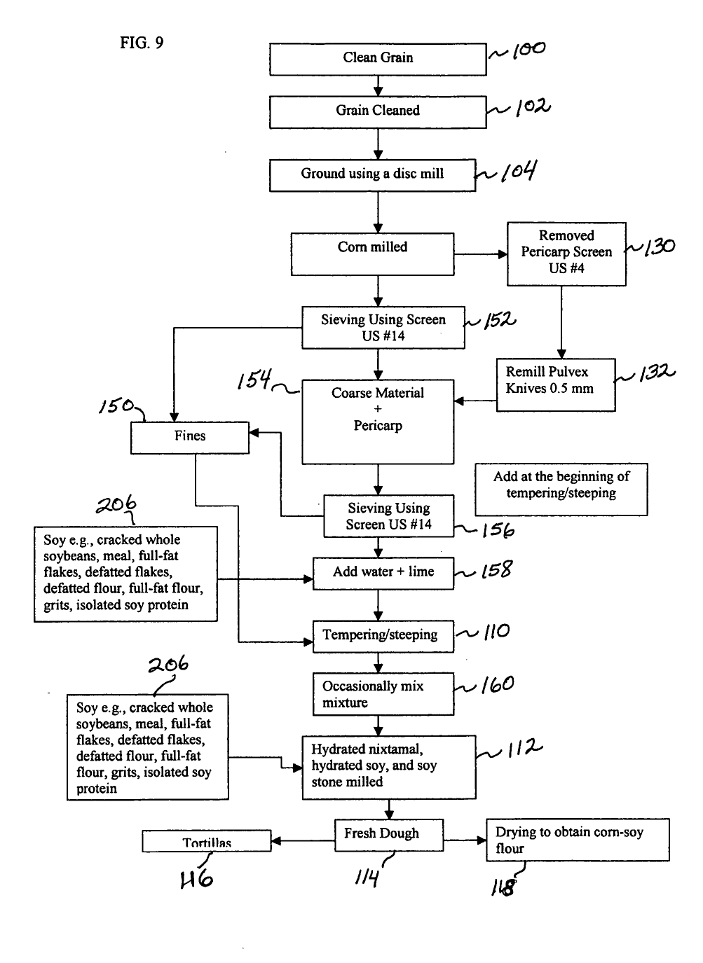

In another embodiment, as shown in FIGS. 7-9, the corn and soy 206 can be hydrated as described above (108, 136, 158), and additional soy 206 can be added to the soy-corn masa just prior to the milling process 112, but after the hydration and tempering processes. The amount of soy can be adjusted between additions at hydration and just prior to milling. The non-hydrated soy and hydrated corn masa (or corn-soy masa) are ground together, generally using a stone mill, to form a homogenous corn-soy dough. Additionally, more water may be added during the milling process to compensate for the added soy.

The milling of the hydrated corn or hydrated corn-soy blend into dough can be performed with a variety of milling apparatuses, including attrition milling apparatuses. In general, the milling approach should be capable of grinding the hydrated corn, hydrated corn-soy, and any post-added non-hydrated soy, to form corn-soy dough with an appropriate consistency. The grinding further causes heating by friction of the hydrated corn or hydrated corn-soy. The mill should apply an appropriate amount of shear force to avoid excessive mechanical damage to the starch or other chemicals of the grain and soy. Similarly, the application of reasonable amounts of shear forces in the grinding generally avoids adversely affecting the physical and rheological properties of the resulting dough.

Suitable milling apparatuses include, for example, a stone mill. In some embodiments, the hydrated corn-soy is milled in a stone mill with an opening between the stones of 0.5 mm. In other embodiments, the opening between the stones of the stone mill is from about 0.1 mm to about 2.0 mm, and in other embodiments, the opening between the stones of the stone mill is from about 0.5 mm to about 1.5 mm. The opening between the stones of the stone mill can be adjusted during the milling process, in response to observations such as energy consumption, rheology of the dough (masa) product, and operating pressure of the mill as nixtamal, and possibly water, are being fed through the screw. While a majority of the water incorporated into the dough is generally added during the hydration process, additional water can be added during the milling process to achieve the total amount of desired water in the fresh dough. The resulting dough composition can be called fresh dough or masa, which is ready for formation into products.

Product Formation

The fresh dough formed from the nixtamalized or hydrated corn-soy blend can be directly converted into food products, such as tortillas 116, or dried 118 to form a dried corn-soy product, see FIGS. 1-9. Suitable food products include tortillas and snacks, which may be formed directly from the dough or from tortillas (e.g., tacos), which are first formed prior to snack formation. Alternatively, all or a portion of the nixtamalized corn-soy blend can be dried into a dried corn-soy product. The dried corn-soy product can be ground into dried flour, e.g., instant dry masa flour. Instant dry masa flour can be later rehydrated to form dough for the formation of tortillas, snacks and the like.

For the formation of tortillas from the fresh dough, a desired unit mass of dough is separated from the total dough. The unit mass of dough is shaped into a selected tortilla shape, which is generally flat and round, although other shapes can be used. The tortillas generally are cooked on a hot surface. For manual production by consumers, the tortillas can be cooked on each side at a temperature from about 180° C. to about 210° C. for about 2 minutes per side. For commercial scale production, the tortillas can be cooked, for example, on a band conveyor or the like in which the tortillas are cooked at temperatures of about 300° C. to about 320° C. In general, the heat can be generated by any reasonable source, such as steam, dielectric cooking, microwave cooking, infrared cooking, natural gas cooking, LP gas cooking, kerosene cooking and the like. Snacks, such as tortilla chips, can be formed from the tortillas by frying the tortillas or a portion thereof.

Drying of the fresh dough involves the removal of a significant portion of the water from the dough. Following drying, the moisture content generally is less than about 15 weight percent of the dough. The drying process can lead to additional gelatinization of the corn starch. Therefore, it may be desirable to modify the hydration process, for example, by shortening the hydration time and/or the total amount of water. The drying process generally can be adapted from processes for dehydrating conventionally nixtamalized corn. For example, the dough can be dried by the injection of warm dry air. Following drying, the dried corn-soy product generally can be milled into a dry flour using any suitable mill. The dry corn-soy flour can be stored for reasonable periods of time prior to consumption. When desired, the dried corn-soy flour can be rehydrated to form rehumidified dough. The rehumidified dough can be processed into tortillas and other food products similarly to the fresh dough.

### EXAMPLES

### Example 1

### Formation of Fresh Corn Dough (Commercial)

This example describes the formation of fresh dough and tortillas from nixtamalized whole corn based on the processes described herein.

The sample of unfragmented whole corn was cleaned to remove impurities, using a 0.8 cm×0.8 cm screen. Ten kilograms (10 kg.) of the corn was placed into a pot, 2.0 parts by weight boiling water per part corn was added, and 2% lime was added as a fraction of the initial corn weight. Upon combining the ingredients, they were mixed, and allowed to steep for a period of 12-18 hours. The nixtamal (cooked corn with 2% lime) was washed and rinsed twice to remove excess lime and pericarp.

After hydration the hydrated corn mixture was fed gradually into a stone mill. The volcanic stone had 8 grooves and an 8-inch diameter. The stones of the stone mill were appropriately spaced to achieve the desired consistency of dough (masa), but not directly measured. From each kilogram of corn, 1.4 kilograms of fresh masa was obtained. The fresh dough was blended with instant dry masa flour in a ratio of 70% fresh nixtamal dough and 30% instant dry masa flour and was ready to be used to make tortillas and tortilla derivatives. The dough had a moisture content of about 55%.

### Example 2

### Formation of Fresh Corn Dough (Traditional Nixtamal)

This example describes the formation of fresh dough and tortillas from nixtamalized whole corn based on the processes described herein.

The sample of unfragmented whole corn was cleaned to remove impurities, using a 0.8 cm×0.8 cm screen. Ten kilograms (10 kg.) of the corn was placed into a pot, 2.0 parts by weight boiling water per part corn was added, and 2% lime was added as a fraction of the initial corn weight. Upon combining the ingredients, they were mixed, and allowed to steep for a period of 12-18 hours. The nixtamal (cooked corn with 2% lime) was washed and rinsed twice to remove excess lime and pericarp.

After hydration the hydrated corn mixture was fed gradually into a stone mill. The volcanic stone had 8 grooves and an 8-inch diameter. The stones of the stone mill were appropriately spaced to achieve the desired consistency of dough (masa). From each kilogram of corn, 1.4 kilograms of fresh masa was obtained. Dough was obtained with a water content of about 45 weight percent. The fresh dough was ready to be used to make tortillas and tortilla derivatives.

### Example 3

### Formation of Fresh Corn Dough-Faster Process

This example describes the formation of fresh dough from nixtamalized whole corn based on the faster process described herein.

A sample of unfragmented whole corn was cleaned to remove impurities, using a 0.8 cm×0.8 cm screen. The unfragmented whole corn was then cracked. Ten kilograms (10 kg.) of the cracked corn was placed into a pot, and 0.8 parts (8 kg) by weight boiling water per part cracked corn was added and 0.55 weight percent lime was added as a fraction of the initial cracked corn weight. Upon combining the ingredients, they were mixed and allowed to steep, without additional heat. The mixture was allowed to steep for a period of about 3 hours. The nixtamal (cooked corn with lime) did not require washing and rinsing.

After hydration, the hydrated corn mixture was fed gradually into a stone mill, as described in Example 1. Dough (masa) was obtained with a water content of about 40 weight percent. The fresh dough was ready to be used to make tortillas and tortilla derivatives.

General Processing Features for Examples Involving Formation of Fresh Corn-Soy Dough—Soy Added at Start of Hydration

This example describes the formation of fresh dough from hydrated whole cracked corn and soy based on the faster process described herein. The following is the general process followed for Examples 4-7.

A sample of cracked corn was cleaned to remove impurities, using a 0.8 cm×0.8 cm screen. Ten kilograms (10 kg.) of the cracked corn and 0.4 kilograms of soy was placed into a pot, and 0.8 parts by weight (8 kg) boiling water per part corn was added and 0.55 weight percent lime was added as a fraction of the initial corn weight. Upon combining the ingredients, they were mixed and allowed to steep without additional heat. The mixture was allowed to steep for a period of about 3 hours. The hydrated corn-soy mixture did not require washing and rinsing.

After hydration, the hydrated corn-soy mixture was fed gradually into a stone mill, as described in Example 1. Dough (masa) was obtained with a water content of about 40 weight percent. The fresh dough was ready to be used to make tortillas and tortilla derivatives.

### Example 4

### Formation of Fresh Corn-Soy Dough-Soy Added at Start of Hydration With a First Soy Composition

The general process described above was used to make a corn-soy dough. The soy utilized in Example 4 was defatted soy flakes that were toasted to achieve a Protein Dispersability Index (PDI) of 20 and then milled to provide a 100-mesh flour. The resulting dough is characterized below.

### Example 5

### Formation of Fresh Corn-Soy Dough-Soy Added at Start of Hydration With a Second Soy Composition

The general process described above was used to make a corn-soy dough, however, a specific soy source was used in preparing the corn-soy dough. The soy utilized in Example 5 was defatted soy flakes that were toasted to achieve a PDI of 20 and then milled to provide a 200-mesh flour. The resulting dough is characterized below.

### Example 6

### Formation of Fresh Corn-Soy Dough-Soy Added at Start of Hydration With a Third Soy Composition

The general process described above was used to make a corn-soy dough, however, a specific soy source was used in preparing the corn-soy dough. The soy utilized in Example 6 was defatted soy flakes that were toasted to achieve a PDI of 20. The resulting dough is characterized below.

### Example 7

### Formation of Fresh Corn-Soy Dough-Soy Added at Start of Hydration With a Fourth Soy Composition

The general process described above was used to make a corn-soy dough, however, a specific soy source was used in preparing the corn-soy dough. The soy utilized in Example 7 was defatted soy flakes that were toasted to achieve a PDI of 30 and then milled to form a meal. The resulting dough is characterized below.

### Example 8

### Formation of Fresh Corn-Soy Dough With the Soy Added Just Before Milling

The process of Example 3 was used to make a corn-soy dough, however, the soy was added just before milling of the nixtamalized corn. No soy was added at the hydration stage, so only the corn was hydrated, and a faster nixtamalization process was used. The soy added to the nixtamalized corn was defatted soy flakes that were toasted to achieve a PDI of 20 and then milled to provide a 100-mesh flour. The resulting dough is characterized below.

### Example 9

### Testing of the Corn-Soy Dough in Tortillas Product

The dough formed in the above examples was characterized with respect to several characteristics that relate to the desirability of the dough in the formation of tortillas. The masa produced in the above examples was generally of a quality to form masa discs for making tortillas.

Tortillas were made from the dough produced as described in the above Examples 1-8 on a commercial tortilla machine (Celorio type) from fresh masa that was shaped into masa discs of about 14-cm diameter and 1.3 mm thickness. The masa discs were baked on a rotating hot plate of the machine at about 290° C. for about 20 seconds on one side, followed by 25 seconds baking on the opposite side. The tortillas were turned again for puffing. The tortillas were then cooled and stored or tested.

Testing Tortillas Made From Dough Made By the Process in Examples 1-8

The tortillas were evaluated for color with the use of a Miniscan HunterLab colorimeter. The tortillas were also tested for rollability by rolling the tortilla over a rod or tube (2 cm diameter). The degree of breaking of the tortilla is rated on a scale from 1 -5, where 1 or 0% rupture corresponds to tortillas that do not break and 5 corresponds to tortillas that break at a 100% rupture. Five tortillas were used for each Example in conducting the rollability test. The tortillas were used one at a time and rolled around a 2 cm diameter rod. The results are reported in a table below.

Referring to Table C, the rollability of the tortilla made from Example 1 or Example 2 masa was better than the tortilla made from Example 3 masa, especially after one day of aging. Generally, the tortillas made with masa from Examples 4-7 showed good first day rollability, with a decline in the second day of aging. The tortilla made with the masa from Example 8 showed the poorest rollability, as compared to the tortillas made by processes in the other Examples.

Fresh Masa Test

The texture (firmness and adhesiveness) of masa and texture of the tortillas were evaluated using a Universal Texture Analyzer TA-XT2 from Texture Technology Corp. A small portion of fresh masa is filled into a plastic ring of diameter of 7.5 cm and height of 1.9 cm. and placed in the aluminum platform of the Texture Analyzer TA-XT2. The probe TA-18, a stainless steel sphere of 1.27 cm diameter, is attached to the equipment head and tested in the masa at a speed of 2 mm/sec with a penetration into the masa of 4 mm. The dough (masa) is tested for cohesion and adhesion. The cohesive forces act within a single substance, such as within the dough to hold or stick the dough together. Adhesion is measured as the force between different substances, such as between the dough and the spherical probe, measuring how well the dough sticks to the probe. “Sticky” dough, with higher adhesion, (masa) is difficult to work with and, therefore, stickiness is not a desirable trait for the masa.

Referring to Table A, the masa produced using the faster process and soy added at the beginning of the hydration step (Examples 4-7) generally resulted in masa with higher cohesion than the commercial masa (Example 1). Example 7, where soy meal was added, had lower cohesive strength, which may have been affected by the soy meal particle size. The higher cohesion figures indicate that the internally, the dough tends to stick together. The higher cohesion may make “puffing” of the tortilla more difficult.

As noted above, adhesion of the dough, that is how well the dough adheres to other substances, was also measured. A higher value for the adhesion indicates that the dough is stickier. Examples 4 and 5 showed higher adhesion than the commercial masa (Example 1), while the other measured Examples were generally similar to Example 1 in adhesion characteristics.

Moisture Content/pH/Water Activity

Referring to Table D, the moisture content and pH of tortillas made from masa from Example 3 were generally lower than tortillas made with masa from Example 2 or Example 1. The tortillas made with masa from Examples 4-8 (containing soy) generally had a first day higher moisture content (and more similar to Example 2) than the tortillas made with masa from Examples 1 and 3. The moisture content of the tortillas may affect characteristics such as rollability, shelf life, flexibility, integrity and tenderness.

The water activity level of the tortillas can have an effect on the shelf life of the tortilla. The values for Aw represent the amount of “free” or unbound water that is in the tortilla, where a value of 1.0 represents all “free” water. Hence, values for “free” water in food will be less than 1, with 0 being very dry and 1.0 for pure water. Most foods fall between 0.2 (for very dry foods) and 0.99 (for moist fresh foods). The Aw value refers to the availability of water in a food to microorganisms to allow for their growth. Hence, the higher the value of the Aw, the more the environment is ripe for supporting the growth of bacteria, yeasts and molds.

The water activity (Aw) is measured as equilibrium relative humidity (ERH). Water activity values represent the ratio of water vapor pressure of the food to the water vapor pressure of pure water under the same conditions. This ratio (fraction) is multiplied by 100 to obtain the ERH that the food would produce if enclosed with air in a sealed container at constant temperature. Therefore, a food with an Aw of 0.6 (dried fruit) will produce an ERH of 60%. The Aw of bread is 0.95 (an Aw of above 0.95 is generally sufficient to support the growth of microorganisms) and the Aw of fresh meat and fish is 0.99, thus showing that a small numerical difference in Aw can be significant as to microorganism activity on/in the food. Thus, the Aw value can be a predictor of growth of bacteria, yeast and molds and, hence, a predictor of shelf life. A Beckman Hygroline Moisture meter, Nova Sina/Rotronic Moisture Humidity Meter, Hygrodynamic Hygrometer, WeatherMeasure Relative Humidity System and AquaLab Model CX-2T can be used to measure the Aw value. The Aw values for the tortillas made in the above Examples were measured using the AquaLab Model CX-2T, which is available Decagon Devices, Inc.

The Aw values for Examples 5-7 were generally lower than the Aw values for Example 2 (traditional nixtamal) and Example 1 (commercial). However, after three days, the tortillas from Examples 6-7 spoiled. The tortilla from Example 2 was not evaluated, however the tortillas from Examples 1 and 5 were tested and retained their shelf life. Generally, the pH of tortillas made using the faster process (Examples 3-8) had a lower first day pH than Examples 1 and 2.

Tortilla Texture

The tensile strength and the cutting force of the tortillas are evaluated using the Universal Texture Analyzer TA-XT2. Tensile strength was tested to determine if the tortilla would be expected to hold food, yet not be tough or rubbery. An 8.6 cm ×3.7 cm strip of the middle part of the tortilla is placed on the TA-96 probe, which is attached to the head of the Texture Analyzer. The head of the Texture Analyzer moves the probe upward at a speed of 2 mm/sec. until the tortilla breaks. In this test, the hardness or brittleness of the tortilla is measured.

The same tortilla piece is used to measure cutting force. The tortilla piece is placed on the TA-90 attachment, which is a knife 6.93 cm wide and 3 mm thick. The Texture Analyzer head moves the probe downward at 2 m/sec for 15 mm or until the tortilla is cut. The results for the above two tests are reported in peak force, g-f (grams-force force) or Kg-f (kilogram-force). In these tests, the force to break or cut a cooked tortilla is measured.

Generally, the tensile strength (day 1) of the tortillas from Examples 4-8 (containing soy) was lower than the tortillas from Examples 1-3 (not containing soy). However, the tensile strength of the tortillas from Example 8 (mill-step added soy) was somewhat higher (first day) than Examples 4-7 (containing hydrated soy). The tensile strength measurement would tend to be an indicator as to how well the tortilla could hold food, not tear, and yet not be tough or rubbery. Generally, higher tensile strength is preferred, up to a point, before the tortilla becomes tough.

In general, the force required to cut the tortillas from Examples 4-8 (containing soy) was lower than for Example 2 (the standard masa tortilla). However, the tortillas from Examples 4 and 8 showed cutting forces more similar to tortillas from Example 2, whereas the tortillas from Examples 5, 6, 7 showed cutting force more similar to tortillas from Example 1 (commercial masa). In some cases (Examples 4, 7, and 8) the second day cutting force was greater than for the tortillas from Example 2, evidencing some toughness.

Color

The Miniscan HunterLab colorimeter was used to evaluate tortilla color. The parameter “L” measures the degree of lightness and has a range of 100 for white to 0 for black. The “a” and “b” parameters are indicative of chromasty. The positive “a” values are related to red color and the negative values are related to green; the positive “b” values are associated with yellow and the negative values are associated with the color blue.

As noted in Table B, with respect to color, the tortillas made with the masa from the Examples were generally light in color. The tortillas made from Examples 3-8 masa, were generally slightly darker than the tortillas made from Example 2 or Example 1 masa. However, the tortillas made from masa from Example 8 were slightly lighter in color (soy was added at the milling step) as compared to tortillas made with masa from Examples 4-7 (soy was added at the beginning of hydration).

Tables A, B, C and D Provide the Results of Tortillas Made with the Dough from the Above Examples and Tested for the Above-noted Qualities.

TABLE A
Masa

| | Cohesion | Adhesion | | |
|---|---|---|---|---|
| | (g-f) | (g-f) | Moisture % | pH |
| Example 1 | 94.72 | −13.53 | 55.7 | 7.5 |
| Example 2 | N/E | N/E | N/E | N/E |
| Example 3 | N/E | N/E | N/E | N/E |
| Example 4 | 115.0 | −20.5 | 50.8 | 7.14 |
| Example 5 | 122.93 | −19.83 | 50.5 | 7.5 |
| Example 6 | 102.75 | −13.18 | 50.5 | 7.5 |
| Example 7 | 65.71 | −11.58 | 51.6 | 7.5 |

TABLE B
Color

| | Day 1 | | | Day 2 | | | Day 3 | | |
|---|---|---|---|---|---|---|---|---|---|
| | L | a | b | L | a | b | L | a | b |
| Ex- | 66.2 | 1.29 | 15.09 | 66.25 | 1.47 | 15.07 | 66.4 | 1.22 | 15.04 |
| ample 1 | | | | | | | | | |
| Ex- | 64.74 | 1.51 | 15.82 | 62.06 | 2.37 | 16.13 | NE | NE | NE |
| ample 2 | | | | | | | | | |
| Ex- | 56.69 | 2.05 | 14.98 | 56.72 | 2.30 | 16.40 | NE | NE | NE |
| ample 3 | | | | | | | | | |
| Ex- | 58.91 | 1.83 | 15.40 | 61.97 | 2.26 | 15.93 | NE | NE | NE |
| ample 4 | | | | | | | | | |
| Ex- | 55.8 | 2.2 | 15.1 | 58.3 | 2.4 | 16.0 | 57.5 | 1.5 | 14.4 |
| ample 5 | | | | | | | | | |
| Ex- | 55.06 | 2.09 | 15.3 | 55.7 | 2.68 | 16.07 | F | F | F |
| ample 6 | | | | | | | | | |
| Ex- | 59.6 | 2.03 | 16.06 | 55.14 | 2.6 | 15.87 | F | F | F |
| ample 7 | | | | | | | | | |
| Ex- | 60.29 | 1.52 | 15.29 | 57.15 | 2.01 | 14.86 | NE | NE | NE |
| ample 8 | | | | | | | | | |

NE = Not Evaluated
F = Fermented/spoiled

TABLE C
Rollability

| | Day 1 | Day 2 | Day 3 |
|---|---|---|---|
| Example 1 | 1 1 1 1 1 | 1 1 1 1 1 | 1 1 1 1 1 |
| Example 2 | 1 1 1 1 1 | 1 1 2 1 2 | NE NE NE NE NE |
| Example 3 | 4 1 1 1 4 | 1 3 2 2 3 | NE NE NE NE NE |
| Example 4 | 1 1 1 1 2 | 2 2 1 3 2 | NE NE NE NE NE |
| Example 5 | 1 1 1 1 1 1 | 2 2 1 2 2 | 3 4 3 3 4 |
| Example 6 | 1 1 1 1 3 | 1 1 2 2 1 | F F F F F |
| Example 7 | N/E | N/E | N/E |
| Example 8 | 1 3 2 2 3 | 1 1 2 3 | NE NE NE NE NE |

TABLE D
Shelf Life

| | Moisture | | | Tensile | Cuttery |
|---|---|---|---|---|---|
| | (%) | pH | Aw | Force (g-f) | Force (g-f) |
| Example 1 | | | | | |
| Day 1 | 47.9 | 8.07 | 0.98 | 146.33 | 696.78 |
| Day 2 | 44.4 | 7.84 | 0.98 | 188.07 | 1354.20 |
| Day 3 | 43.5 | 7.50 | 0.98 | 167.73 | 1148.85 |
| Example 2 | | | | | |
| Day 1 | 44.6 | 8.34 | 0.99 | 227.58 | 1183.27 |
| Day 2 | 41.5 | 8.14 | 0.99 | 270.71 | 1707.42 |
| Day 3 | NE | NE | NE | NE | NE |
| Example 3 | | | | | |
| Day 1 | 37.1 | 7.49 | 0.97 | 229.93 | 998.42 |
| Day 2 | 37.7 | 7.23 | 0.98 | 140.09 | 1779.55 |
| Day 3 | NE | NE | NE | NE | NE |
| Example 4 | | | | | |
| Day 1 | 41.4 | 7.57 | 0.98 | 124.34 | 1009.45 |
| Day 2 | 39.8 | 7.42 | 0.98 | 122.05 | 2364.56 |
| Day 3 | NE | NE | NE | NE | NE |
| Example 5 | | | | | |
| Day 1 | 41.1 | 7.52 | 0.97 | 136.54 | 624.61 |
| Day 2 | 34.7 | 7.12 | 0.96 | 174.46 | 1432.11 |
| Day 3 | 35.4 | 7.20 | 0.96 | 225.07 | 1349.46 |
| Example 6 | | | | | |
| Day 1 | 41.4 | 7.70 | 0.97 | 96.02 | 568.42 |
| Day 2 | 35.9 | 7.55 | 0.97 | 98.92 | 760.70 |
| Day 3 | F | F | F | F | F |
| Example 7 | | | | | |
| Day 1 | 41.1 | 7.66 | 0.97 | 128.44 | 771.63 |
| Day 2 | 36.5 | 7.47 | 0.97 | 253.66 | 2114.44 |
| Day 3 | F | F | F | F | F |
| Example 8 | | | | | |
| Day 1 | 37.54 | 7.39 | 0.98 | 150.65 | 1472.72 |
| Day 2 | 34.9 | 7.51 | 0.98 | 184.30 | 2350.95 |
| Day 3 | NE | NE | NE | NE | NE |

NE = Not Evaluated
F = Fermented/spoiled

### Example 10

### Formation of Dry Corn Flour From Faster Method For Hydrating Corn

This example describes the production of dry corn flour from nixtamalized corn formed with whole cracked corn kernels, using the faster nixtamalization process.

Whole corn kernels were cleaned and ground to form cracked corn. The milling of the corn was continued until the cracked corn had an average particle size of 4 mm. The cracked corn was placed into a mixer. Water at about 0.8 parts by weight to part cracked corn was added to the mixer at a temperature from 85° C. to 90° C., and lime was added to a concentration of 0.3 weight percent relative to the weight of the corn. The hydration mixture was hydrated for 2 hours.

After hydration was completed, the hydrated corn composition was ground in a stone mill with a separation between the stones of 0.5 mm. The resulting pre-cooked fresh dough had a hydration level of 50%. The fresh dough was dehydrated to form a dried corn product. The dried corn product was milled to form dry corn flour. The dried corn flour was suitable for forming tortillas following re-hydration.

### Example 12

### Formation of Dry Corn-Soy Flour From Hydrated Corn-Soy

This example describes the production of dry corn-soy flour from nixtamalized corn-soy formed with corn kernels and defatted soy flakes.

Corn kernels were cleaned and ground to form cracked corn. The milling of the corn was continued until the cracked corn had an average particle size of 4 mm. The soy used in Example 12 was defatted soy flakes that were toasted to achieve a PDI of 20. The cracked corn and defatted soy flakes were placed into a mixer. Approximately 10 kg. corn and 0.5 kg. defatted soy flour were combined. Water at about 0.8 parts by weight to part corn was added to the mixer at a temperature from 85° C. to 90° C., and lime was added to a concentration of 0.3 weight percent relative to the weight of the corn. The hydration mixture was hydrated for a time of about 2 hours. After hydration was completed, the hydrated corn-soy composition was ground in a stone mill with a separation between the stones of 0.5 mm. The resulting pre-cooked fresh dough had a hydration level of about 54%. The fresh dough was dehydrated to form a dried corn-soy product. The dried corn product was milled to form dry corn-soy flour. The dried corn-soy flour was suitable for forming tortillas following re-hydration. The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What we claim is:

1. A method for producing a soy and corn dough, the process comprising milling a corn-soy composition, the corn-soy composition comprising a hydrated corn and soy blend.

2. The method of claim 1, wherein no more than 10.0 weight percent soy relative to the cracked corn is combined with the cracked corn

3. The method of claim 1 wherein the corn-soy composition is formed by combining cracked corn and soy with water and lime and hydrating the mixture.

4. The method of claim 3, wherein the soy and the cracked corn are hydrated for a time of at least 5 minutes.

5. The method of claim 3, wherein the water is heated prior to the combination of the cracked corn, soy and water.

6. The method of claim 3, wherein no more than 0.55 weight percent lime relative to the cracked corn weight is combined with the cracked corn, soy and water.

7. The method of claim 3, wherein no more than 0.4 weight percent lime relative to the cracked corn weight is combined with the cracked corn, soy and water.

8. The method of claim 3, wherein the soy and the cracked corn are hydrated for a time less than about 5 hours.

9. The method of claim 3, wherein the soy and the cracked corn are hydrated for a time less than about 2 hours.

10. The method of claim 3, wherein soy is additionally added to the corn-soy composition of claim 3, forming a modified corn-soy composition.

11. The method of claim 10, wherein the milling of the modified corn-soy composition of claim 10 is performed by a stone mill.

12. The method of claim 1, wherein the milling of the soy-corn composition is performed with a stone mill.

13. The method of claim 11, wherein the stones of the mill have a gap of between 0.2 mm and 0.8 mm.

14. A method for forming a tortilla comprising cooking at least a portion of the dough of claim 1.

15. The method of claim 1, wherein hydrated cracked corn is formed by combining cracked corn with water and lime and hydrated.

16. The method of claim 15, wherein the soy is added to the hydrated cracked corn to form the corn-soy composition.

17. The method of claim 15, wherein the milling of the corn-soy composition is performed by a stone mill.

18. A corn and soy dough composition comprising a blend of soy and hydrated crushed corn.

19. The corn and soy dough composition of claim 18, wherein the soy comprises hydrated soy.

20. The corn and soy dough composition of claim 18 comprising no more than about 10 weight percent soy relative to the crushed corn weight.

21. The corn and soy dough composition of claim 18 wherein the pH is from about 6 to about 8.

22. The corn and soy dough composition of claim 18 wherein the soy comprises hydrated soy and non-hydrated soy.

23. The corn and soy dough composition of claim 18 comprising no more than about 0.55 weight percent lime relative to the crushed corn weight.

24. The corn and soy dough composition of claim 18 comprising no more than about 0.4 weight percent lime relative to crushed corn weight.

25. The corn and soy dough composition of claim 18 wherein the corn is whole grain corn.

26. The corn and soy dough composition of claim 18 wherein the corn is degerminated.

27. The corn and soy dough composition of claim 18 wherein the corn has the pericarp substantially removed.

28. The corn and soy dough composition of claim 18 wherein the soy is selected from a group comprising soy flakes, soy meal, soy flour, defatted soy flour and isolated soy protein.
